(19) United States
(12) Patent Application Publication
(10) Pub. No.: US 2024/0012866 A1
(43) Pub. Date: Jan. 11, 2024

(54) QUEUING ANALYTICS EVENTS BEFORE CONSENT

(71) Applicant: Shopify Inc., Ottawa (CA)

(72) Inventors: Mark Joseph NORTHCOTT, Greely (CA); Christian HARDEN, Encino, CA (US)

(73) Assignee: Shopify Inc., Ottawa (CA)

(21) Appl. No.: 18/086,851

(22) Filed: Dec. 22, 2022

Related U.S. Application Data
(60) Provisional application No. 63/359,030, filed on Jul. 7, 2022.
(60) Provisional application No. 63/425,089, filed on Nov. 14, 2022.

(51) Int. Cl. G06F 16/958; G06F 9/38; H04L 67/50

(52) U.S. Cl. CPC G06F 16/958; G06F 9/3855; H04L 67/535

(57) ABSTRACT

In one aspect, at a client computing device, a set of web browser analytics events generated by user web browsing activity is enqueued. Responsive to the enqueued set of web browser analytics events satisfying a condition, prompting for consent to perform data analytics is performed. Responsive to the prompting, input is received corresponding to a received consent to perform at least some of the data analytics. Based on the received consent, at least a part of the enqueued set of web browser analytics events is uploaded to a server for use in performing the at least some of the data analytics.

### CROSS REFERENCE TO RELATED APPLICATIONS

The present application claims the benefit of U.S. Provisional Patent Application No. 63/359,030, filed on Jul. 7, 2022, and U.S. Provisional Patent Application No. 63/425,089, filed on Nov. 14, 2022. The entire disclosure of each of the two aforementioned provisional patent applications is hereby incorporated by reference hereinto.

### TECHNICAL FIELD

The present disclosure relates to web browser analytics, and more particularly to system and method for queuing analytics events before consent.

### BACKGROUND

A user's interaction with a website via web browser on a client computing device may generate various types of web browser analytics events. The events may include user input events (e.g., link clicks, scrolling events, cursor movement events, video views/interactions, virtual shopping cart interactions, and downloads), browser performance events (e.g., page rendering time, page load time, and load times of assets such as images, scripts, fonts, and video), browser environment events (e.g., browser, browser version, browser height and/or width), and referral events (e.g., receipt of an HTTP request with a header containing a “Referer” field value identifying a referring web page). Such web browser analytics events may be of interest to the website owner for assessing website and/or advertising effectiveness.

Jurisdiction-specific privacy regulations may require user consent for the user's web browser analytics event data to be collected, handled, or stored for data analytics purposes. Seeking a user's consent typically involves displaying a consent UI at the client computing device, receiving user input indicative of the provided consent, and uploading the user input to a web server for appropriate processing. These steps consume processing resources (e.g., processor cycles, power, and/or memory) at the client computing device and the web server.

Conventional websites may display a consent/cookie banner that blocks any use of the website pending receipt from the user of data use consent. Users for whom there is no evidence of past consent (e.g., users who are visiting such a website for the first time or who have deleted previously stored cookies from the website) may be blocked from freely browsing the website until the data use consent is provided. Consent UIs may have a single cancel/allow or be broken into a list of options that the user is consenting to.

### SUMMARY

Systems and methods described herein promote computational efficiency by buffering web browser analytics event data at a client computing device pending consent for use thereof for data analytics purposes. Depending upon whether consent is provided and the nature of any provided consent, the client computing device may refrain from uploading some or all of the buffered web browser analytics event data to a server for data analytics processing. Whatever data analytics processing is performed may be limited to web browser analytics event data of greater value.

In one aspect, there is provided a computer-implemented method comprising: enqueuing, at a client computing device, a set of web browser analytics events generated by user web browsing activity; responsive to the enqueued set of web browser analytics events satisfying a condition, prompting, at the client computing device, for consent to perform data analytics; receiving, by the client computing device responsive to the prompting, input corresponding to a received consent to perform at least some of the data analytics; uploading, by the client computing device based on the received consent, at least part of the enqueued set of web browser analytics events to a server for use in performing the at least some of the data analytics.

In some embodiments, the method further comprises identifying, based on the received consent, the at least part of the enqueued set of web browser analytics events from amongst the enqueued set of web browser analytics events, wherein the at least part of the enqueued set is identified based on the at least some of the data analytics.

In some embodiments, the enqueuing comprises: for each of the web browser analytics events of the set: determining a type of the web browser analytics event; and storing a tag indicative of the type of the web browser analytics event in association with the web browser analytics event; and wherein the identifying the at least part of the enqueued set of web browser analytics events is based in part on the tag associated with each respective enqueued web browser analytics event of the at least part of the enqueued set.

In some embodiments, the method further comprises determining a geographic location of the client computing device and determining the data analytics for which the consent is prompted based, at least in part, on the geographic location of the client computing device.

In some embodiments, the method further comprises determining a geographic location of the client computing device, wherein the condition is specific to the determined geographic location of the client computing device.

In some embodiments, the prompting for the consent is customized based, at least in part, upon the enqueued set of web browser analytics events.

In some embodiments, the user web browsing activity comprises a user conversion and wherein the condition is satisfied when the enqueued set of web browser analytics events includes at least one user conversion event.

In some embodiments, the user conversion event is an indicator of at least one of: user completion of an electronic form; user creation of an account; user login to an existing account; an addition of an item to a virtual shopping cart; a selection of the item for immediate purchase; and a selection of a checkout option for purchasing a set of items in the virtual shopping cart.

In some embodiments, the user web browsing activity comprises completing at least a threshold number of pageviews and the condition is satisfied when the enqueued set of web browser analytics events includes pageview events indicative of at least the threshold number of pageviews.

In some embodiments, the user web browsing activity comprises completing a browsing session of at least a threshold duration and the condition is satisfied when the enqueued set of web browser analytics events indicates a web browsing session of at least the threshold duration.

In some embodiments, the enqueued set of web browser analytics events satisfies the condition when the enqueued set of web browser analytics events has exceeded a threshold size.

In some embodiments, the condition is satisfied when the enqueued set of web browser analytics events comprises a user input event indicative of browsing to identity-significant web content.

In some embodiments, the method further comprises, based on the received consent, associating the uploaded at least part of the enqueued set of web browser analytics events with an account at the server.

In some embodiments, the enqueuing, at the client computing device, the set of web browser analytics events generated by user web browsing activity comprises storing an indicator associated with one or more web browser analytics events of the set of web browser analytics events; the receiving, by the client computing device responsive to the prompting, input corresponding to the received consent to perform at least some of the data analytics comprises receiving input corresponding to a consent associated with the indicator; and the uploading, by the client computing device based on the received consent, at least part of the enqueued set of web browser analytics events to the server comprises uploading the one or more web browser analytics events associated with the indicator.

In some embodiments, the set of web browser analytics events is not enqueued in persistent storage media.

Embodiments may include combinations of the above features.

In another aspect, there is provided a system comprising: a client computing device including: one or more processors; and a memory storing computer-executable instructions that, when executed by the one or more processors, cause the one or more processors to: enqueue, at the client computing device, a set of web browser analytics events generated by user web browsing activity; responsive to the enqueued set of web browser analytics events satisfying a condition, prompt, at the client computing device, for consent to perform data analytics; receive, by the client computing device responsive to the prompting, input corresponding to a received consent to perform at least some of the data analytics; and upload, based on the received consent, at least part of the enqueued set of web browser analytics events to a server for use in performing the at least some of the data analytics.

In some embodiments, the instructions, when executed by the processor, further cause the one or more processors to identify, based on the received consent, the at least part of the enqueued set of web browser analytics events from amongst the enqueued set of web browser analytics events, wherein the at least part of the enqueued set is identified based on the at least some of the data analytics.

In some embodiments, the enqueuing comprises: for each of the web browser analytics events of the set: determining a type of the web browser analytics event; and storing a tag indicative of the type of the web browser analytics event in association with the web browser analytics event; and wherein the identifying the at least part of the enqueued set of web browser analytics events is based in part on the tag associated with each respective enqueued web browser analytics event of the at least part of the enqueued set.

In some embodiments, the prompting for the consent is customized based, at least in part, upon the enqueued set of web browser analytics events.

Embodiments may include combinations of the above features.

In another aspect of the present disclosure, a non-transitory computer-readable medium storing instructions that, when executed by one or more processors of a client computing device, cause the one or more processors to: enqueue, at the client computing device, a set of web browser analytics events generated by user web browsing activity; responsive to the enqueued set of web browser analytics events satisfying a condition, prompt, at the client computing device, for consent to perform data analytics; receive, by the client computing device responsive to the prompting, input corresponding to a received consent to perform at least some of the data analytics; and upload, by the client computing device based on the received consent, at least part of the enqueued set of web browser analytics events to a server for use in performing the at least some of the data analytics.

### BRIEF DESCRIPTION OF THE DRAWINGS

In the figures which illustrate example embodiments,

FIG. 1 is a block diagram of an e-commerce platform, according to an example embodiment;

FIG. 2 is an example of a home page of an administrator, according to an example embodiment;

FIG. 3 is a block diagram of a system embodying aspects of the present disclosure;

FIG. 4 is a block diagram illustrating a client computing device of the system of FIG. 3 in greater detail;

FIG. 5 is a flowchart illustrating operation of the client computing device of FIG. 4 for queuing analytics events before consent;

FIG. 6 is a schematic diagram of memory of the client computing device of FIG. 4 during the operation of FIG. 5;

FIG. 7 depicts a user interface displayed at the client computing device of FIG. 4;

### DESCRIPTION

In this document, any use of the term “exemplary” should be understood to mean “an example of” and not necessarily to mean that the example is preferable or optimal in some way.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

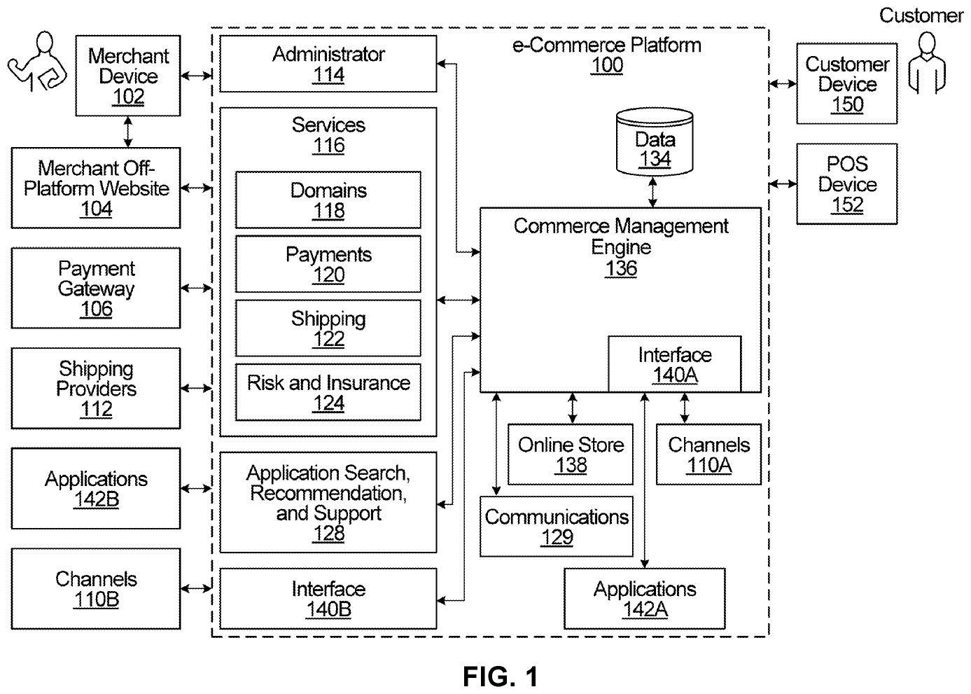

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

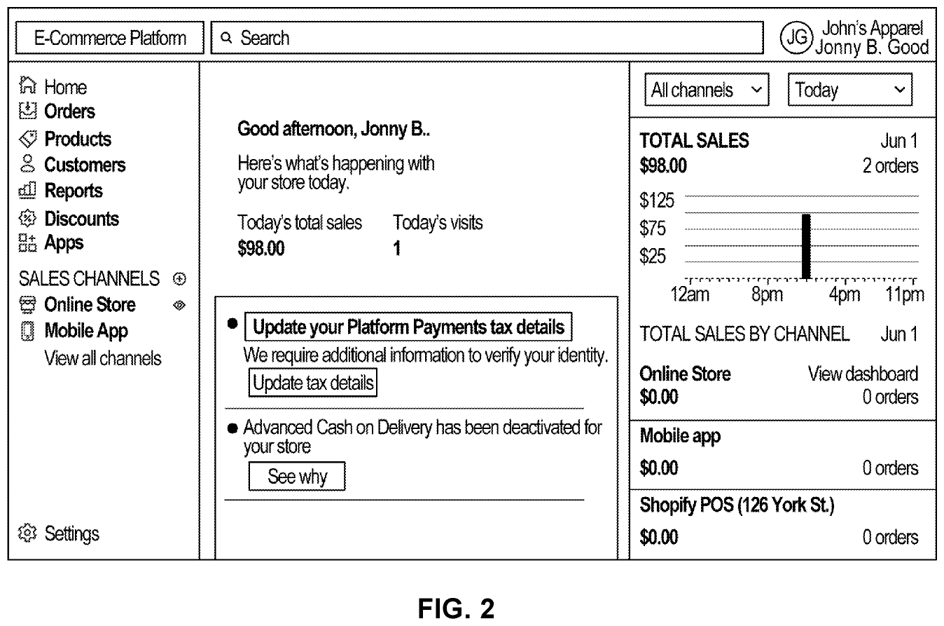

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

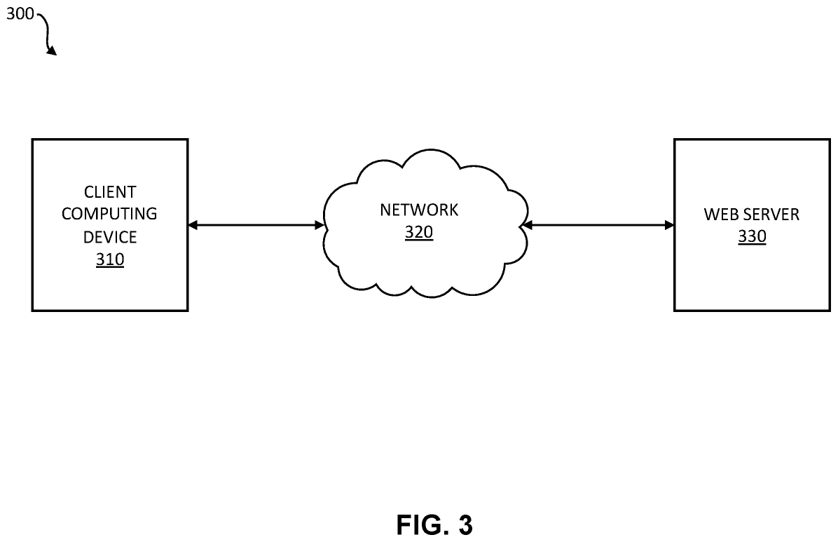

FIG. 3 is a schematic diagram of a system 300 embodying aspects of the present disclosure. The system 300 includes a client computing device 310 and a web server 330. The client computing device 310 and web server 330 are communicatively coupled by a network 320, which may be or may include the internet, via a network communication protocol (e.g., an internet protocol). In some embodiments, the client computing device 310 may be a customer device 150 or a POS device 152, as described above in connection with FIG. 1. The client computing device 310 may be associated with a user, who may be a customer of an e-commerce platform 100, as described above in connection with FIG. 1. In some embodiments, the web server 330 may be part of the e-commerce platform 100.

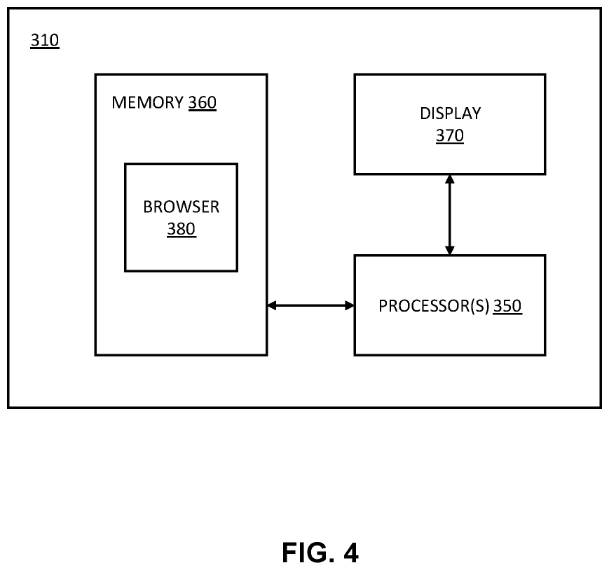

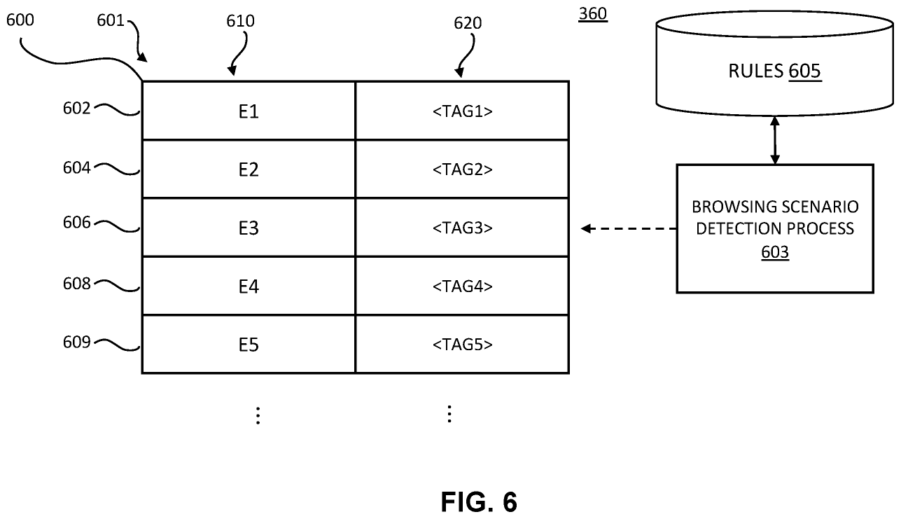

FIG. 4 is a simplified schematic depiction of the client computing device 310. The client computing device 310 is a form of computing device, such as a computer, a laptop computer, a tablet computing device, a smartphone, another form of mobile computing device, or the like. The computing device 310 includes at least one processor 350 communicatively coupled with tangible, non-transitory memory 360 and a display 370. The memory 360 may be volatile memory, non-volatile memory, or a combination of these. To facilitate connection to the network 320, the client computing device 310 may further include a network interface controller or network adapter (not illustrated). Alternatively, or in conjunction, the computing device may include suitable antennas, transceivers, and software (not illustrated) for wireless communication, e.g., conforming to Wi-Fi™ standard(s) such as IEEE 802.11 a/b/g/n/ac/ax, with network 320 (FIG. 6). By virtue of its network connectivity, the client computing device 310 may be considered as a form of endpoint.

The memory 360 of client computing device 310 includes a web browser 380 software application, or simply “browser” 380, suitable for browsing the world wide web. It is by virtue of the web browser—a form of client software application—that the computing device 310 is referred to as a “client” computing device 310. The browser 380 may be capable of browsing web content written in HTML, template language, JavaScript, or other languages or formats.

The web server 330 (FIG. 3) comprises hardware and software that serves web content responsive to requests received via the HyperText Transfer Protocol (HTTP) or HyperText Transfer Protocol Secure (HTTPS) protocols. The web server 330 may host a merchant website 104, as described above in connection with FIG. 1. The merchant website 104 may be associated with an online store 138, as described above in connection with FIG. 1.

As will be described, the system 300 of FIG. 3 collects web browser analytics event data using a method that promotes computational efficiency of both the client computing device 310 and the web server 330. The method may be considered to be based on the premise that, for data analytics purposes, some web browsing sessions are of greater interest than others. The amount of computational resources to be allocated for data analytics purposes will depend upon such factors as, e.g., web browsing duration and/or the click trail of the user.

In overview, according to this system and method, when a user (e.g., a user for whom there is no evidence of past data use consent for the website) visits a website hosted at the web server 330, the user may be permitted to browse the website, e.g., as an “anonymous” user. The anonymous user is not prompted for data use consent upon initially accessing the website. As the user's web browsing activity progresses, the client computing device 310 engages in two activities, e.g., in parallel.

Firstly, the client computing device 310 enqueues web browser analytics event data corresponding to the user's web browsing activity. In this context, the term “enqueues” does not necessarily connote the use of a queue data structure. Rather, in this context, the term “enqueues” more broadly means “buffers” or “stores.” The buffering or storing may be performed using any suitable storage mechanism(s), including but not limited to queue data structures, stack data structures, database tables and records, or otherwise. Notably, the enqueued web browser analytics event data is not used for data analytics purposes at this stage but rather is merely temporarily buffered, e.g., in local memory of the web browser, pending determination of its availability and/or value for data analytics purposes.

Secondly, the client computing device 310 continually (e.g., periodically and/or on an event-driven basis) assesses the user's web browsing activity to determine whether the user has engaged in any one of a set of predetermined web browsing scenarios for which data analytics is likely to be of particular interest or value. The assessment is performed based on the enqueued web browser analytics event data and a set of rules specifying one or more conditions. The rules may be embedded in website code or may be distinct therefrom.

If the assessment indicates that the user has engaged in a web browsing scenario of interest (examples provided below), only then is the user prompted for data collection consent. Responsive to the prompting, the user may provide one of three types or “degrees” of consent: full consent, partial consent, or no consent. As will be described, the enqueued web browser analytics event data may be treated differently depending upon which of the three degrees of consent has been provided. Notably, event data for which no consent is provided is deemed unavailable for data analytics and is ultimately deleted. Event data deemed unavailable for data analytics may for example be purged periodically, in response to a user input, or by some other ruleset. Other event data, for which consent is provided or for which no consent is required in an operative jurisdiction, is deemed available for data analytics and is retained for that purpose.

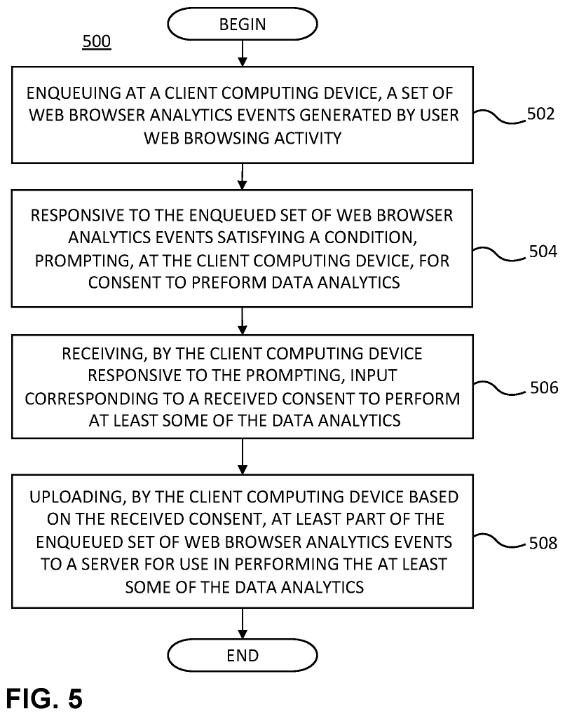

FIG. 5 is a flowchart illustrating operation 500 of the client computing device 310 for queuing analytics events before consent according to this method. At the commencement of operation 500, it is presumed that a user of client computing device 310 is interacting with the browser 380 to browse web content hosted at web server 330 (FIG. 3). In this example, the web content being browsed is an e-commerce website of a notional company, XYZ Corporation, which may be the merchant website 104 and/or online store 138 of FIG. 1.

As the user browses the XYZ Corporation website, web browser analytics events are generated in accordance with the browsing activity of the user. The web browser analytics events may include but are not limited to: user input events (e.g., link clicks, scrolling events, cursor movement events, video views/interactions, virtual shopping cart interactions, and downloads), browser performance events (e.g., page rendering time, page load time, and load times of assets such as images, scripts, fonts, and video), browser environment events (e.g., browser, browser version, browser height and/or width), and referral events (e.g., referrals to the XYZ Corporation website from third party websites).

Such web browser analytics may be of interest to a website proprietor for various reasons. One reason may be to gain insights as to how a website is being used in practice, which may help identify mechanisms for improving website performance. Another reason may be to assess attribution for actions performed on the website. This may include attributions to external activities which may be received in the form of HyperText Transfer Protocol (HTTP) Referer field in HTTP headers or urchin tracking module (UTM) parameters or other data in HTTP POST or HTTP GET requests. Attribution may also be determined based on internal website activities. For example, in the case when multiple paths of browsing (or “clicktrails”) can lead to a sale, a sale that results from a direct browsing of collections may be attributed differently than a sale via a search engine results page.

In operation 502 (FIG. 5), a set of web browser analytics events generated by the user web browsing activity is enqueued (i.e., buffered temporarily) at the client computing device 310. FIG. 6 is a block diagram schematically depicting the memory 360 of client computing device 310 during operation 502 of FIG. 5. The memory 360 may for example be, or may include, local memory associated with the browser 380, such as, for example, the “localStorage” JavaScript mechanism, the “sessionStorage” JavaScript mechanism, in-memory variables, URL parameters, object representations in a Document Object Model (DOM), or cached HTML/XML/JSON data.

In some embodiments, the memory 360 (or portions thereof) may enable data to be persisted at the client computing device 310. For example, the memory 360 (or portions thereof) may comprise “persistent” or non-volatile storage media, and the client computing device 310 may be configured to enqueue the web browser analytics events in the persistent or non-volatile storage media (e.g. using the “localStorage” JavaScript mechanism, cookies, etc.) such that the enqueued events become accessible across more than one browsing session (e.g. to the browser application and/or, more generally, the client computing device 310).

In some embodiments, the memory 360 (or portions thereof) may be unable to persist data (i.e., across sessions) at the client computing device 310. For example, if the web browser analytics events are enqueued using in-memory variables at the client computing device 310, the enqueued data (or at least the portion thereof enqueued using only in-memory variables) may be irretrievable (e.g. to the browser application) across a session boundary (e.g., after a browsing application on the client computing device 310 is closed, a tab in the browser application is closed, the client computing device 310 loses power, the client computing device 310 is reset, etc.).

In some embodiments, some or all of the memory 360 may be capable of persisting data, but the capability may not be employed/exercised when enqueuing the web browser analytics events. Additionally or alternatively, the client computing device 310 may enqueue the set of web browser analytics events (or portions thereof, or parts of each event, etc.) to portions of the memory 360, but not to those portions comprising persistent or non-volatile storage media. For example, the client computing device 310 may enqueue the set of web browser analytics events only to, e.g., in-memory variables of a browser application. Additionally or alternatively, the client computing device 310 may select and write to persistent or non-volatile storage media only those portions or parts of the web browser analytics events whose persistence is “strictly necessary in order for the provider of an information society service explicitly requested by the subscriber or user to provide the service” (as these terms are used in, e.g., Directive 2002/58/EC of the European Parliament and of the Council of 12 Jul. 2002 concerning the processing of personal data and the protection of privacy in the electronic communications sector, as amended, herein incorporated by reference in its entirety). In this way, the user of the client computing device 310 may be afforded more privacy with regard to the set of web browser analytics events.

As shown in FIG. 6, the memory 360 includes a buffer 600. The purpose of buffer 600 is to temporarily store (e.g. based on the properties of the memory 360 and/or on when certain consents or non-consents are received) web browser analytics events that occur as the user browses web content, e.g., during a current browsing session, before consent is sought. For clarity, the term “browsing session” as used herein refers to one or more visits to a website over a time interval, which may be considered to end, for example, when a user browses to another website, is inactive for some predetermined time period (e.g., 30 minutes), or when a browser application is closed (e.g., in legacy desktop browsers that dump memory when the browser is closed or computer rebooted). In some embodiments, the time interval may be determined by the lifespan of one or more cookies associated with the web content. In some embodiments, the time interval may be determined by web server 330. In some embodiments, the time interval may be determined based on some combination of factors, including, e.g., those described above.

In FIG. 6, the buffer 600 is depicted as a table in which each row 602, 604, 606, 608, and 609 represents a respective enqueued (buffered) web browser analytics event. The first column 610 stores an indication of the event, which in FIG. 6 is represented using the notation “E #,” where the ‘#’ symbol is a positive integer uniquely identifying the event. The second column 620 stores a tag (described below) indicative of the type of web browser analytics event stored in the first column 610. It will be appreciated that the rows and columns of FIG. 6 are symbolic and do not necessarily correspond to data structure features. The buffer 600 may be implemented in various ways. In some embodiments, the buffer 600 may be a queue data structure. In some embodiments, the buffer 600 may be one or more tables and/or records in a database (e.g., a relational database, a graph database). A key/value store could also be used where, e.g., the key is the unique identifier of the event and the value is the data captured for the event (e.g. target URL of a clicked link). Other data structures and/or storage constructs may be used.

In the example of FIG. 6, the buffer 600 stores a set 601 of five enqueued web browser analytics events E1, E2, E3, E4, and E5. For illustration, the five events in this example are as follows:
E1—referral to XYZ Corporation website from social media application ZBook
E2—user clicked on “products” page link internal to XYZ Corporation website
E3—user clicked on “PowerBar” product page link internal to XYZ Corporation website
E4—user scrolled to bottom of “PowerBar” page of XYZ Corporation website
E5—user clicked on “Add to Cart” button on “PowerBar” page of XYZ Corporation website

In the present embodiment, for each of the web browser analytics events E1-E5 stored in column 610, the type of web browser analytics event is determined. This may for example be done using a lookup table or comparable mechanism. In some embodiments, web browser analytics events may be categorized into different types by their purpose. For example, some web browser analytics events may be useful for measuring content performance. Other web browser analytics events may be useful for applying market research to generate audience insights. In other embodiments, web browser analytics events may be categorized into different types by feature or operating characteristic(s). For example, some web browser analytics events may actively scan device characteristics for identification. Other web browser analytics events may use geolocation data. In some embodiments, web browser analytics events may be categorized into different types by permutations or combinations based on one or more properties/aspects thereof—e.g., based on purposes, features, times, and/or other properties of the web browser analytics events.

Based on web browser analytics event type determination, a tag indicative of the type of the web browser analytics event is generated and stored in association with the web browser analytics event. In FIG. 6, the tag is represented in column 620 using the notation <TAG #>, where the “#” symbol is an integer equal to the integer value of the “E #” identifier in column 610 of the same row. The tags may for example be expressed in a markup language, such as Standard Generalized Markup Language (SGML). In some embodiments, each event that is enqueued may be classified (and accordingly tagged) based on a schema or model defined to allow granular consent to be managed, e.g., by feature, purpose, special feature, special purpose, or vendor. As will be described, these tags may be used to categorize the events in some scenarios, e.g., upon user provision of only partial consent to perform data analytics upon the enqueued web browser analytics events, to facilitate identifying web browser analytics events for which data analysis (analytics) is permissible. Tags are not necessarily generated and/or stored in all embodiments.

In operation 504 (FIG. 5), responsive to the enqueued set of web browser analytics events satisfying a condition, the client computing device prompts the user for consent to perform data analytics. In the present embodiment, operation 504 may be effected by operation of a browsing scenario detection process 603 (FIG. 6). The process may be a background process that is periodically triggered, e.g., upon detection of a new web browser analytics event (i.e., on an event-driven basis).

When triggered, the process 603 assesses whether the set of web browser analytics events currently stored in buffer 600 satisfies one or more conditions. The condition(s) may be indicative of predetermined browsing scenarios. In at least some embodiments, the scenarios may correspond to user conversion events. In this context, the term “user conversion” refers to user completion of an action that a website proprietor wishes the user to complete when interacting with the website. A common example for an e-commerce website is selection of a product to add to a virtual shopping cart or completion of a purchase. Other examples of user conversion events, which may apply equally to non e-commerce websites, may include viewing a video, completing a form, or otherwise engaging with a website in a desired manner.

The predetermined web browsing scenario(s) that, if detected, may be considered to satisfy the condition of operation 504, may include:
electronic form completion/submission
account creation
login to an existing account
addition of an item to a virtual shopping cart
selection of an item for immediate purchase
selection of a checkout option for purchasing a set of items in a virtual shopping cart
browsing at least a threshold number of pageviews
browsing for at least a threshold duration
enqueueing web browser analytics event data of at least a threshold size or amount
browsing identity-significant web content (e.g., as evidenced by successful entry of user login credentials followed by browsing to user-specific content)

As noted above, some, if not all, of the above-enumerated web browsing scenarios may be considered to constitute user conversion events indicative of a user conversion. Thus, in operation 504, the condition may be considered to be satisfied when the enqueued set of web browser analytics events includes at least one user conversion event, e.g., as identified above. A set of rules 605 for use in determining whether the condition is satisfied may be embedded in website code or may be distinct therefrom. In some embodiments, the set of rules 605 is dynamically configurable.

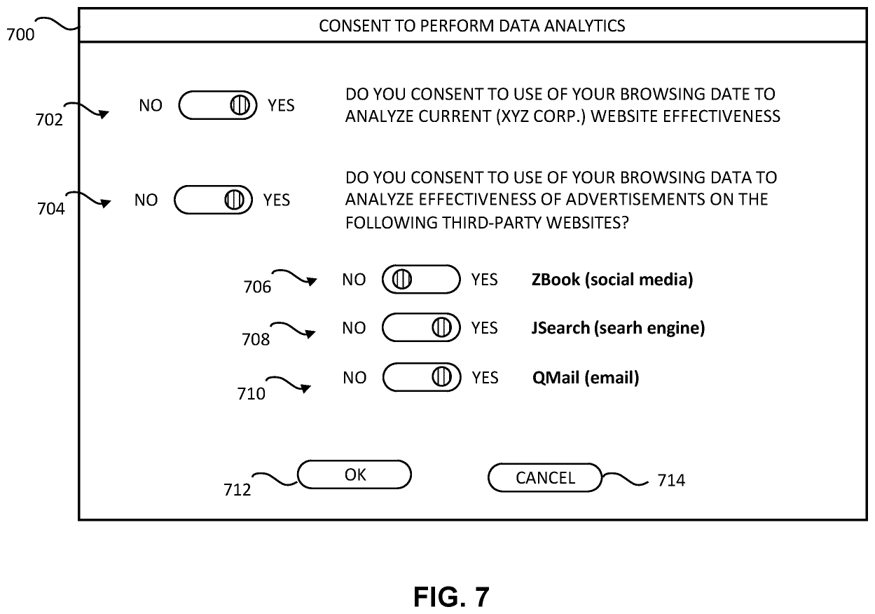

In the present embodiment, the operation 504 further triggers the presentation of a user interface 700 (FIG. 7) on display 370 of the client computing device 310. Referring to FIG. 7, the example user interface 700 is a dialog box including multiple user input mechanisms, including radio buttons and standard buttons in this example. Each radio button is associated with a respective prompt for consent to perform a particular type of data analytics using web browser analytics event data already enqueued in buffer 600, as well as any such data received in the future. In this example, the dialog box 700 presents two primary prompts.

A first primary prompt 702 prompts for consent for performing data analytics to analyze the effectiveness of the first-party website, i.e., of the XYZ Corporation website that the user is currently browsing. In this example, it is presumed that the associated radio button (which may be referenced by the same reference numeral 702 as the associated prompt—a convention of FIG. 7) has been set to “YES” from a default “NO” setting, indicating that the consent has been provided.

A second primary prompt 704 prompts for consent for performing data analytics to analyze the effectiveness of the advertisements on third-party websites. In this example, the primary prompt has an associated first-level radio button 704. Three secondary prompts 706, 708, and 710, subordinate to the primary prompt 704, are displayed below the primary prompt 704. Each secondary prompt is associated with a respective second-level radio button 706, 708, and 710. Each of the second-level radio buttons 706, 708, and 710 pertains to a respective third-party website for which consent may be individually provided. In this example, the three websites are: a social media website “ZBook” (second-level radio button 706); a search engine website “JSearch” (second-level radio button 708); and an email website “QMail” (second-level radio button 710). A reason for listing these third-party websites may be that if consent is given, the user's data may be shared with these websites. That data may be used in different ways, depending on the third party, but by consenting the user is permitting to having their data shared with the third party. Another possible reason that these three third-party websites in particular are listed may be that XYZ Corporation has agreed to compensate the proprietors of these three websites for referrals, e.g., based in part on third-party web trackers embedded in the XYZ corporation website. The number and type(s) of websites identified in alternative embodiments may vary.

In FIG. 7, the second-level radio buttons 708 and 710 have been set to “YES” from a default “NO” setting, indicating that the consent has been provided for the latter two websites. In contrast, the “NO” setting for the second-level radio button 706 indicates that consent has not been provided for the “ZBook” social media website. Because at least one of the second-level radio buttons 706, 708, and 710 has been set to “YES,” the first-level radio button 704 is set to “YES,” possibly automatically. Conversely, manual setting of the first-level radio button 704 to “NO” may automatically set all three of the second-level radio buttons 706, 708, and 710 to “NO,” for convenience.

If the condition is not satisfied in operation 504 (FIG. 5), then the client computing device 310 may continue to enqueue web browser analytics events as they arise (operation 502) and may periodically repeat the assessment of operation 504 of whether the condition has been satisfied, e.g., each time a new web browser analytics event is detected.

In operation 506 (FIG. 5), responsive to the prompting, input corresponding to a received consent to perform at least some of the data analytics is received by the client computing device 310. In this example, the input may be received when the user selects an “OK” button 712 to affirm the selections made via user interface 700. In some embodiments, selection of the “CANCEL” button 714 and/or failure to select the “OK” button 712 may lead to one or more presumptions of non-consent. Based on the radio button settings depicted in FIG. 7, the received consent in this example would be a consent to perform data analytics regarding the effectiveness of the XYZ Corporation (first-party) website and to perform data analytics regarding the effectiveness of advertising at the third-party websites JSearch and QMail but not the third-party ZBook website.

In operation 508 (FIG. 5), based on the received consent, i.e., based on the data analytics for which positive consent and/or negative consent has/have been received (via radio button settings in this example), the client computing device 310 uploads at least part of the of the enqueued set of web browser analytics events to the web server 330, for use in performing the data analytics for which consent was received in operation 506. The uploading may be performed in any order, e.g., not necessarily in the order in which the events occurred. The at least part of the enqueued set 601 of web browser analytics events that is uploaded may be identified based on the received consent. In some embodiments, the client computing device 310 may, responsive to receiving input corresponding to the received consent, perform data analytics based on the web browser analytics events associated with the consent, and/or store the web browser analytics events and/or the results of the performed data analytics in persistent or non-volatile storage media. The web browser analytics events associated with the consent may be web browser analytics events that had not been previously stored in persistent or non-volatile storage media.

For example, in the example scenario depicted in FIG. 7, the radio button settings of user interface 700 reflect a positive consent to perform data analytics relating to first-party website effectiveness (“YES” setting of first-level radio button 702). Based on this received positive consent, it may be determined that each of web browser analytics events E2-E4 in buffer 600 (FIG. 6—see descriptions of events E2-E4, above), all of which are relevant to that category of data analytics, is to be uploaded to the web server 330 for data analytics purposes. In this example, the relevance may be determined based on the tag(s) stored in connection with each of the events E2-E4. In some embodiments, multiple tags may be stored for each event, indicating relevance to multiple types of data analytics. Implementations involving “tags” described herein are examples only. In some embodiments, other schemas may be used to store event metadata, and these schemas may or may not involve the storage of anything explicitly declared to be a “tag”.

Conversely, based on the negative consent for performing data analytics relating to effectiveness of advertisements on the ZBook website (“NO” setting of second-level radio button 706), it may be determined that the web browser analytics event E1 in buffer 600 (FIG. 6—see description of event E1, above) should not be uploaded to the web server 330 for data analytics purposes. Advantageously, upload bandwidth and web server computing resources may be conserved as a result.

In some embodiments, the at least part of the enqueued set of web browser analytics events that has been uploaded to the web server 330 by operation 508 (FIG. 5) may be associated with an account, e.g., corresponding to a user identity, at the web server 330. The user identity may be determinable from login credentials entered by the user during web browsing, from browser fingerprinting, or otherwise. The associating may be performed in part based on the received consent. An indication of the received consent may also be uploaded and stored in association with any uploaded web browser analytics events.

In the foregoing example, the consent received responsive to the prompting of operation 504 (FIG. 5) was a partial consent. In particular, the partial consent was a consent to use the web browsing analytics event data for only certain data analytics purposes. In alternative embodiments, the received consent may be another form of partial consent, namely, a consent to the use of only some of the web browsing analytics event data for data analytics purposes. For example, a user may give consent to collect data related to the user's device (e.g., browser user agent). However, the user may refrain from giving consent to collect referral data (i.e., HTTP Referer header), which might otherwise have been used for determining attribution.

It is also possible that, in response to the prompting of operation 504 (FIG. 5), the user may decide not to consent to any use of any of the web browser analytics events for any data analytics purposes. In this “no consent” case, operation 506 (FIG. 5) will not occur, and the enqueued web browser analytics event data will not be uploaded to the web server 330. The buffered data may be deleted, e.g., immediately, at the end of the web browsing session, or upon closing of the browser 380.

Alternatively, it is also possible that, in response to the prompting of operation 504 (FIG. 5), the user may decide to consent to use of all the web browser analytics events for all data analytics purposes. In this “full consent” case, all the enqueued web browser analytics event data will be uploaded to the web server 330, in any order, in operation 508 (FIG. 5). As noted above, the uploaded data may be associated with a user account, e.g., if the web browsing activity represented by the uploaded web browser analytics events is sufficient to identify the user. An indication of the user's (full) consent may also be uploaded to the server and stored in association with the web browsing activity data, e.g., by association with the user account.

In some embodiments, the consent for which the user is prompted, e.g., by way of user interface 700 of FIG. 7, may be stipulated by jurisdiction-specific privacy regulations. Such privacy regulations may require user consent for web browser analytics event data to be used for data analytics purposes. In some embodiments, the prompting performed, e.g., in user interface 700 in FIG. 7, may be based on the privacy regulations of any jurisdiction of interest in the world (e.g. the strictest regulations of those of the jurisdictions of interest). Additionally or alternatively, the standards for data analytics consent may be hard-coded within the system 300, e.g., in website code.

In other embodiments, a geographic location of the client computing device may be determined, e.g., before operation 504 (FIG. 5) is performed. This may be done using known techniques, such as by Internet Protocol (IP) address location analysis or otherwise. The data use consent for which the user is prompted in operation 504 may then be based, or may be conditional, at least in part, upon the determined geographic location of the client computing device.

For example, if privacy regulations applicable in the determined geographic location do not require user consent for collecting certain types of web browser analytics events or for performing certain types of web browsing data analytics, then the prompting may omit the relevant consent(s). For example, if it were not necessary, in an operative jurisdiction as determined from a detected geographic location, to obtain consent to use browsing data for first-party website effectiveness analysis, the first prompt 702 of the user interface 700 (FIG. 7) could be omitted. This may limit or avoid unnecessary processing, which may improve computational efficiency. Thus, the data analytics for which consent is prompted may be determined based, at least in part, on a determined geographic location of the client computing device 310.

The set of rules 605 (FIG. 6), i.e., the condition(s), used to determine when to prompt for user consent may, in some embodiments, be specific to the geographic location. For example, the set of rules 605 may include conditional logic that is based on geographic location.

In some embodiments, the prompting for consent performed in operation 504 (FIG. 5) is customized based, at least in part, upon the enqueued set of web browsing analytics events. For example, such embodiments may present an abridged user interface similar to the user interface 700 in FIG. 7, including second-level radio button 706 but without second-level radio buttons 708 and 710. The basis for including the radio button 706, and associated prompt, may be that the enqueued set of web browser analytics events in buffer 600 was examined and was found to include a referral from the ZBook social media website. Conversely, the basis for excluding the radio buttons 708 and 710, and associated prompts, may be that the enqueued set of web browser analytics events in buffer 600 does not include any referrals, or other events, relevant to either of the JSearch search engine website or the QMail email website.

The above-described system and method may conserve computational resources, such as processor cycles and power, at the client computing device 310. For example, the client computing device 310 may refrain from prompting for data use consent and from uploading web browser analytics event data to a server for analysis when the browsing activity of the user is unlikely to be valuable for data analytics purposes. In another example, computational resources (e.g., processor cycles, power, and/or memory) may be conserved at the web server, in that data analytics is only performed for web browser analytics event data of the greatest value.

Various alternative embodiments are possible.

The number and type of prompts in user interface 700 of FIG. 7 may differ in alternative embodiments. In alternative embodiments, the user interface 700 may be something other than a dialog box.

In at least some embodiments described above, the web server 330 is used in connection with an e-commerce platform 100. In some embodiments, the web content being browsed may be wholly unrelated to e-commerce. In that case, the web server 330 may have no connection to any e-commerce platform(s).

In at least some of the embodiments described above, web browser analytics events generated by the user web browsing activity may be in a buffer 600 of memory 360 at a client computing device 310. In some embodiments, the buffer 600 may be, additionally or alternatively, effected using URL parameters.

For example, the enqueued browser analytics events may be encoded and stored as one or more URL parameters, which may be, e.g., sent by the client computing device 310 when requesting web content and/or incorporated into subsequent web content (e.g., links, scripts, script variables) received by the client computing device 310 so as to effect the enqueuing of the events during a browsing session (e.g., before content is obtained).

As a user clicks through multiple web pages, corresponding web browser analytics events may be encoded and further appended to links within the web page and/or incorporated into scripts or script variables associated with the web page.

An example scenario may be as follows:
1. user browses to XYZcorporation.com;
2. events are buffered by continually appending event information, embedded within the “queue” URL parameter, to all hyperlinks within the website, e.g., “?queue=${base74([event1,event2,event3])}” where “eventN” indicates the Nth web browser analytics event that arises as the user continues to browse the website;
3. at an appropriate time, consent is requested from the user for use of the web browser analytics event information for analytics purposes;
4. consent is granted by the user; and
5. the “queue” URL parameter is parsed to access event data web browser analytics purposes.

In some embodiments, the user computing device 310 may be configured to store an indicator (or “hint”) that a consent is required. The required consent may be associated with, for example, one or more individual web browser analytics events, one or more classes of web browser analytics events, and/or one or more kinds of use. The indicator may be stored separately from the enqueued web browser analytics events. For example, where the enqueued web browser analytics events are stored only in portions of the memory 360 that are not persistent or non-volatile storage media (to, e.g., provide better privacy to the user with regard to the web browser analytics events), the indicator may be stored the memory 360 without similar restrictions. Other indicators may be similarly stored as the need for other consents arises during a browsing session. The user computing device 310 may further be configured to, in response to the consent being provided, use the indicator to retroactively obtain the associated web browser analytics events (or data derived therefrom) for, e.g., subsequent storage, sending out, and/or use (i.e., in the manner consented to).

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of an optical storage medium such as CD-ROM or DVD, memory, hard disk, flash drive, RAM, ROM, cache, and the like.

A processor may include one or more cores that may enhance speed and performance of a multiprocessor. In some embodiments, the process may be a dual core processor, quad core processors, other chip-level multiprocessor and the like that combine two or more independent cores.

The methods and systems described herein, e.g., in connection with web server 330, may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client (e.g., such as client computing device 310) that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures, such as network 320 of FIG. 3 for example. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM, and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A computer-implemented method comprising:
enqueuing, at a client computing device, a set of web browser analytics events generated by user web browsing activity;
responsive to the enqueued set of web browser analytics events satisfying a condition, prompting, at the client computing device, for consent to perform data analytics;
receiving, by the client computing device responsive to the prompting, input corresponding to a received consent to perform at least some of the data analytics;
uploading, by the client computing device based on the received consent, at least part of the enqueued set of web browser analytics events to a server for use in performing the at least some of the data analytics.

2. The method of claim 1, further comprising:
identifying, based on the received consent, the at least part of the enqueued set of web browser analytics events from amongst the enqueued set of web browser analytics events, wherein the at least part of the enqueued set is identified based on the at least some of the data analytics.

3. The method of claim 2 wherein the enqueuing comprises:
for each of the web browser analytics events of the set:
determining a type of the web browser analytics event; and
storing a tag indicative of the type of the web browser analytics event in association with the web browser analytics event;
and wherein the identifying the at least part of the enqueued set of web browser analytics events is based in part on the tag associated with each respective enqueued web browser analytics event of the at least part of the enqueued set.

4. The method of claim 1 further comprising determining a geographic location of the client computing device and determining the data analytics for which the consent is prompted based, at least in part, on the geographic location of the client computing device.

5. The method of claim 1 further comprising determining a geographic location of the client computing device, wherein the condition is specific to the determined geographic location of the client computing device.

6. The method of claim 1 wherein the prompting for the consent is customized based, at least in part, upon the enqueued set of web browser analytics events.

7. The method of claim 1 wherein the user web browsing activity comprises a user conversion and wherein the condition is satisfied when the enqueued set of web browser analytics events includes at least one user conversion event.

8. The method of claim 7 wherein the user conversion event is an indicator of at least one of:
user completion of an electronic form;
user creation of an account;
user login to an existing account;
an addition of an item to a virtual shopping cart;
a selection of the item for immediate purchase; and
a selection of a checkout option for purchasing a set of items in the virtual shopping cart.

9. The method of claim 1 wherein the user web browsing activity comprises completing at least a threshold number of pageviews and wherein the condition is satisfied when the enqueued set of web browser analytics events includes pageview events indicative of at least the threshold number of pageviews.

10. The method of claim 1 wherein the user web browsing activity comprises completing a browsing session of at least a threshold duration and wherein the condition is satisfied when the enqueued set of web browser analytics events indicates a web browsing session of at least the threshold duration.

11. The method of claim 1 wherein the enqueued set of web browser analytics events satisfies the condition when the enqueued set of web browser analytics events has exceeded a threshold size.

12. The method of claim 1 wherein the condition is satisfied when the enqueued set of web browser analytics events comprises a user input event indicative of browsing to identity-significant web content.

13. The method of claim 1 further comprising, based on the received consent, associating the uploaded at least part of the enqueued set of web browser analytics events with an account at the server.

14. The method of claim 1, wherein:
enqueuing, at the client computing device, the set of web browser analytics events generated by user web browsing activity comprises storing an indicator associated with one or more web browser analytics events of the set of web browser analytics events;
receiving, by the client computing device responsive to the prompting, input corresponding to the received consent to perform at least some of the data analytics comprises receiving input corresponding to a consent associated with the indicator; and
uploading, by the client computing device based on the received consent, at least part of the enqueued set of web browser analytics events to the server comprises uploading the one or more web browser analytics events associated with the indicator.

15. The method of claim 1, wherein the set of web browser analytics events is not enqueued in persistent storage media.

16. A system comprising:
a client computing device including:
one or more processors; and
a memory storing computer-executable instructions that, when executed by the one or more processors, cause the one or more processors to:
enqueue, at the client computing device, a set of web browser analytics events generated by user web browsing activity;
responsive to the enqueued set of web browser analytics events satisfying a condition, prompt, at the client computing device, for consent to perform data analytics;
receive, by the client computing device responsive to the prompting, input corresponding to a received consent to perform at least some of the data analytics; and
upload, based on the received consent, at least part of the enqueued set of web browser analytics events to a server for use in performing the at least some of the data analytics.

17. The system of claim 16 wherein the instructions, when executed by the processor, further cause the one or more processors to:
identify, based on the received consent, the at least part of the enqueued set of web browser analytics events from amongst the enqueued set of web browser analytics events, wherein the at least part of the enqueued set is identified based on the at least some of the data analytics.

18. The system of claim 17 wherein the enqueuing comprises:
for each of the web browser analytics events of the set:
determining a type of the web browser analytics event; and
storing a tag indicative of the type of the web browser analytics event in association with the web browser analytics event;
and wherein the identifying the at least part of the enqueued set of web browser analytics events is based in part on the tag associated with each respective enqueued web browser analytics event of the at least part of the enqueued set.

19. The system of claim 16 wherein the prompting for the consent is customized based, at least in part, upon the enqueued set of web browser analytics events.

20. A non-transitory computer-readable medium storing instructions that, when executed by one or more processors of a client computing device, cause the one or more processors to:
enqueue, at the client computing device, a set of web browser analytics events generated by user web browsing activity;
responsive to the enqueued set of web browser analytics events satisfying a condition, prompt, at the client computing device, for consent to perform data analytics;
receive, by the client computing device responsive to the prompting, input corresponding to a received consent to perform at least some of the data analytics; and
upload, by the client computing device based on the received consent, at least part of the enqueued set of web browser analytics events to a server for use in performing the at least some of the data analytics.
